(19) United States
(12) Patent Application Publication
(10) Pub. No.: US 2015/0023763 A1
(43) Pub. Date: Jan. 22, 2015

(54) ARROW TIP NAIL

(71) Applicant: KYLE AUSTIN FRASCARELLI, CARNEGIE, PA (US)

(72) Inventor: KYLE AUSTIN FRASCARELLI, CARNEGIE, PA (US)

(21) Appl. No.: 14/121,190

(22) Filed: Feb. 22, 2013

(51) Int. Cl. F16B 15/06; F16B 15/00

(52) U.S. Cl. CPC F16B 15/06; F16B 15/00
USPC 411/493

(57) ABSTRACT

An “arrow tip nail” is an impact driven building nail for all sizes, lengths and types of constructing or other building-nail applications, distinctly designed with a triangular arrow shaped tip at the end structure, with lateral protusions on each side where the shank meets the beginning of the design, including a sharp penetrating point at the tip, all for the function of improved piercing and/or structural penetrating ability, as well as increased retention ability, so as to make it easier to go into a structure and harder to withdraw from it by human or natural forces over short or longer periods of time.

### FUNCTIONAL/UTILITY/SPEC DESCRIPTION

An “arrow tip nail” improves penetration and retention ability based on its unique and dynamic triangular and laterally protruding “arrow tip” design for any nail, while utilizing the intuitive and well known practical applications of an arrow-shaped penetrating item as is used in differing industries like hunting, fishing or archery.

### INDUSTRY APPLICATIONS

All commercial and/or private construction, housing, building, roofing, carpentry, wood working, general contracting work and/or household projects.

### SPECIFIC DESIGN/UTILITY APPLICATIONS

For wood or other construction, building and substructure materials, with design to; join, bond, attach, secure, fasten, retain, impact, drive, connect, and/or impress itself into varying wood substructures, or other materials.

### DESIGN/UTILITY ABSTRACT COMPARISON TO COMMON NAILS AND NAIL POINTS

A traditional nail relies on the surface area of the shank making contact with the material it is driven into to help secure the nail within the material. my unique “arrow tip nail design” adds penetration advantages to the piercing end by providing lower friction entry to the material based on its 2 sided arrow shaped point, along with adding greater withdraw resistance from pressure, due to the special triangular arrow design which creates greater horizontal width straight across the shank (or with slight rearward angle), which consequently improves “grab” or “catch” resistance when physical or natural force is applied to remove the nail.

### SPECIFICATION APPLICATION EXAMPLE

When building a home there are various applications for traditional nails whose function is to bond wood or other items together to secure or retain the bond indefinitely, ie: roofing. Unfortunately, various forces of nature and man diminish the bond and cause the traditional nail to come up, or release partially or fully from the driven material. My unique “arrow tip nail” is standardly driven by impact at the head, via hammer or other mechanical device, into varying types of wood or other materials desired to be joined. through unique design, the impact driven “arrow tip nail” attaches itself into the substrate utilizing traditional means and benefits (ie: using the shank & head connection to substrate), but with increased penetration efficiency and stronger embedding due to the arrow tip design allowing ease of entry and strength of retention.

### REFERENCE LIST OF SEARCHES IN USPTO DATABASE

The following references show helpful search findings of “construction or wood impact driven nails” with similar general principles to allow ease of entry or strength of retention. Although, none of the found, or any other known designs, have the unique and exclusively invented and applied for “arrow tip” design on the end structure as part of a nail with unique design and ability to increase and improve the utility and purpose of a driven nail.

Direct Link to Class 411 as Found in USPTO Database:

http://www.uspto.gov/web/patents/classification/uspc411/defs411.htm#C411S439000

Class 411 Description Found at Above Link:

### CLASS 411. EXPANDED, THREADED, DRIVEN, HEADED, TOOL-DEFORMED, OR LOCKED-THREADED FASTENER

Then see: Item D as shown in database under above referencing and describing

“An impact driven fastener (e.g., nail, staple).”

Then, shown below is a description of subclass 439 shown in USPTO database related to “impact driven fasteners, specifically including nails, as indented under class 411.

### SUBCLASS 439

Impact driven fastener, e.g., nail, spike, tack, etc.:

439. This subclass is indented under the class definition. Subject matter drawn to a fastener provided with an impact receiving surface adapted to receive an axially applied force which causes the fastener to penetrate material, substructure, or other work to be fastened.

Then:

See search references below in USPTO database under subclass 493 regarding “end structures” (*493 is also indented under sub class 487). subclass 493 shows similar but significantly different, varying, and/or unequal in design, as well as in overall design and utility focus, to improve end structure (or nail tips) for ease of entry and improved retention capability.

### SEARCH REFERENCES OF RELATED ITEMS

SEARCH REFERENCE: “CLINCH TYPE NAIL”=411/495; 411/179

Or

Barb or Spur Type Projection:

456. This subclass is indented under subclass 451.1. Subject matter wherein the outwardly extending structure comprises an isolated protrusion having a pointed part projecting rearwardly in the direction of the headed structure of the fastener.

Or

Stepped End:

497. This subclass is indented under subclass 493. Subject matter wherein the piercing end comprises a series of sections each successive one of which is of increased transverse dimension in the longitudinal direction towards the impact receiving surface.

Or

Conical Point:

498. This subclass is indented under subclass 493. Subject matter wherein the piercing end in the shape of a surface generated by revolving a right triangle about one of its sides other than the hypotenuse.

### DRAWING SPECIFICATIONS

I, Kyle Austin Frascarelli have invented a new design for a “building nail” as set forth in written and visual specifications:

FIG. 1 is a frontal diagonal view of a building nail showing my new “Arrow Tip Nail Design.”

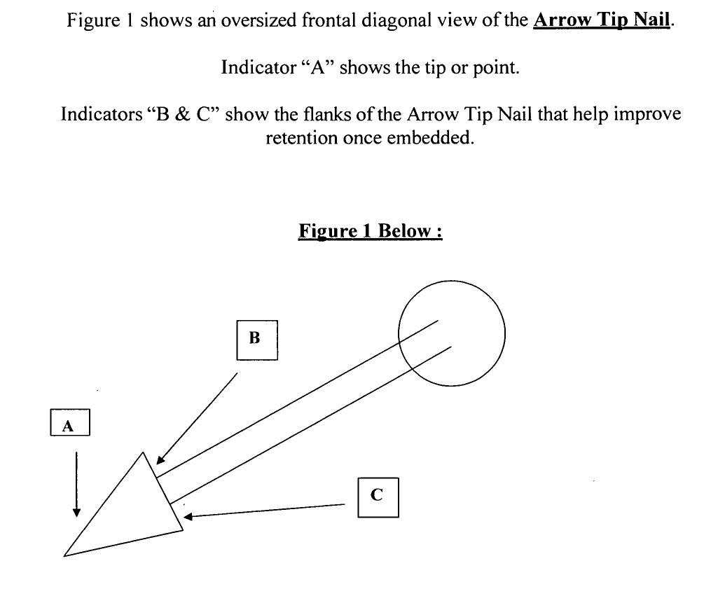

FIG. 2 is a left to right view thereof.

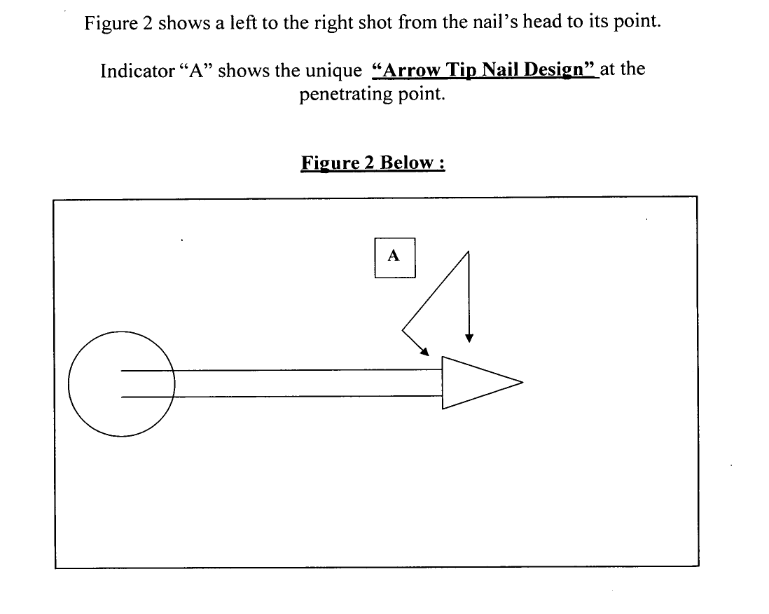

FIG. 3 is a frontal top to bottom view thereof.

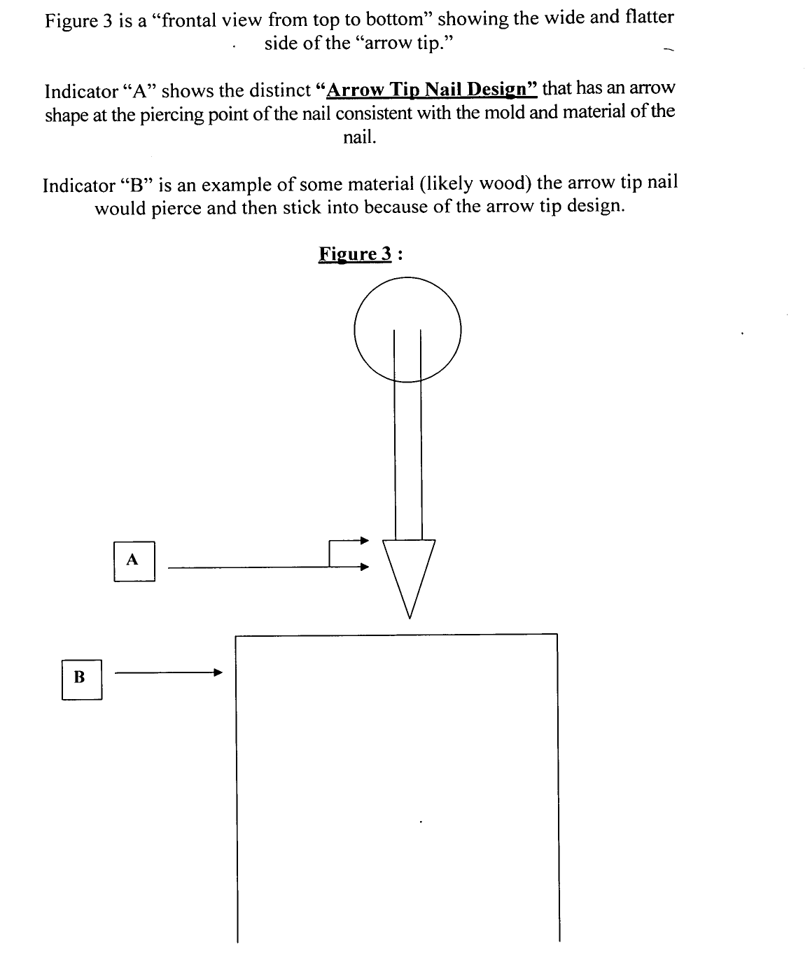

FIG. 4 is a diagonal side view thereof.

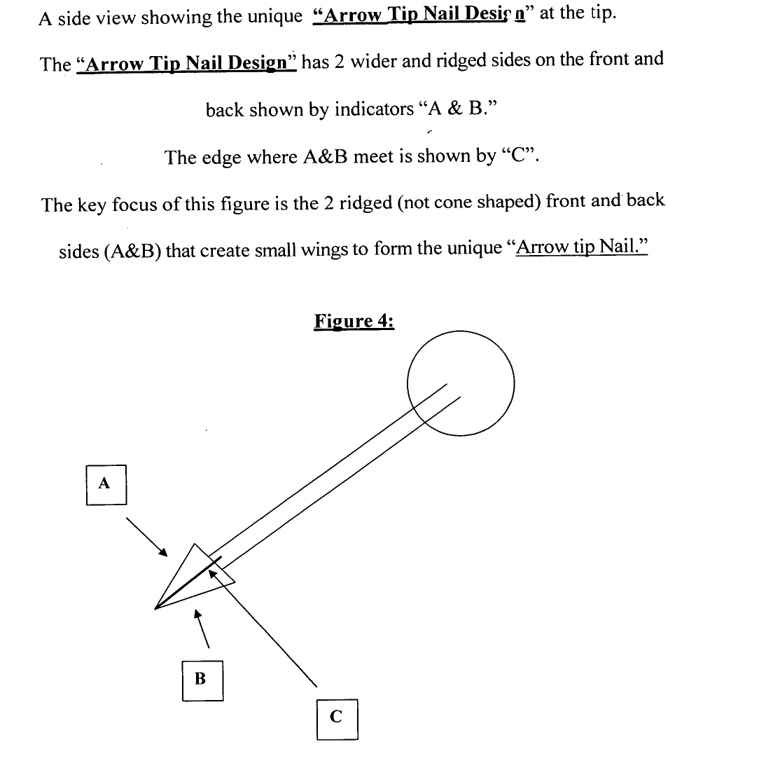

FIG. 5 is a diagonal frontal view & summary of special design claim thereof.

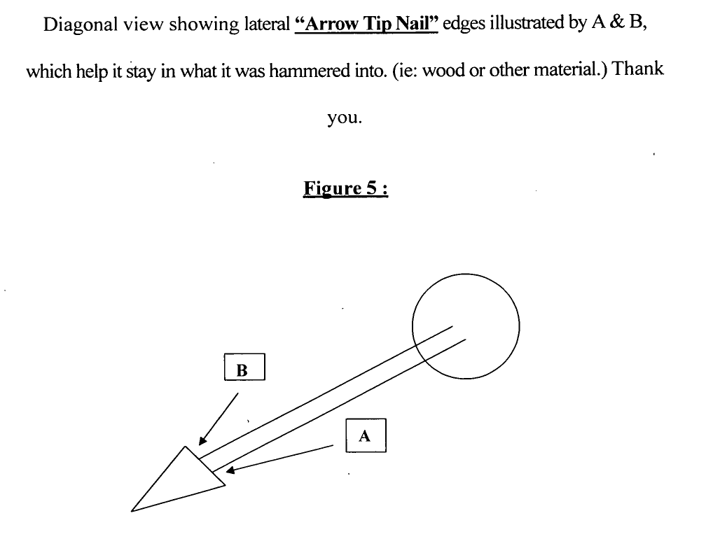

1. I hereby fully declare and claim the invention herein titled as “arrow tip nail” substantially described and formally applied for, as well as exclusively and soley designed and created by Kyle Austin Frascarelli, for the future ownership, property, licensing, marketing, management and profitability claims soley, fully, completely and individually by and for Kyle Austin Frascarelli as here claimed and declared in written oath.
